(19) United States
(12) Patent Application Publication
(10) Pub. No.: US 2017/0066123 A1
(43) Pub. Date: Mar. 9, 2017

(54) DISPLAY BOARD FOR TOOL

(71) Applicant: CHEN-CHI SHIH, Taichung City (TW)

(72) Inventor: CHEN-CHI SHIH, Taichung City (TW)

(21) Appl. No.: 14/848,831

(22) Filed: Sep. 9, 2015

(51) Int. Cl. B25H 3/00

(52) U.S. Cl. CPC B25H 3/003

(57) ABSTRACT

A display board for tool is provided, including a main body, having at least one socket assembling base. The socket assembling base is for a socket to be assembled thereto along an axial direction of the socket assembling base, and a circumferential wall of the socket assembling base is formed with at least one material-reduced portion. The material-reduced portion extends in a direction which is non-perpendicular to the axial direction, and the material-reduced portion unpenetrates through the circumferential wall of the socket assembling base.

### BACKGROUND OF THE INVENTION

Field of the Invention

The present invention relates to a display board for tool, and more particularly to a display board for socket tool.

Description of the Prior Art

Conventionally, a display board for tool as disclosed in TWM326515 at least includes a main body. The main body extends to form an engaging portion and has elastic sheets. Each elastic sheet has an engaging protrusion which is elastically expandable outward to be engaged with a tool.

However, to elastically deform, a penetrated gap is formed between the elastic sheets mentioned above, and the structural strength of the engaging portion is lowered. In addition, after being bent and deformed repeatedly, the elastic sheet is prone to elastic fatigue and unable to fix a tool stably.

The present invention has arisen to mitigate and/or obviate the afore-described disadvantages.

### SUMMARY OF THE INVENTION

The major object of the present invention is to provide a display board for tool, which has a continuous circumferential wall, preferable structural strength and elevated durability. In addition, the display board for tool is not prone to material fatigue and has preferable durability so as to elevate product stability. Furthermore, the display board for tool can be integrally formed by plastic injection, so it is time-saving, fast and convenient to manufacture the display board for tool.

To achieve the above and other objects, a display board for tool is provided, including a main body, having at least one socket assembling base. The socket assembling base is provided for a socket to be assembled thereto along an axial direction of the socket assembling base. A circumferential wall of the socket assembling base is formed with at least one material-reduced portion. The material-reduced portion extends in a direction non-perpendicular to the axial direction, and the material-reduced portion unpenetrates through the circumferential wall of the socket assembling base.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a sketch of a first preferred embodiment of the present invention;

FIG. 2 is a breakdown drawing of the first preferred embodiment of the present invention;

FIG. 3 is a cross-sectional drawing of the first preferred embodiment of the present invention;

FIG. 4 is another cross-sectional drawing of the first preferred embodiment of the present invention;

FIG. 5 is a sketch of a second preferred embodiment of the present invention; and

FIG. 6 is a sketch of a third preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

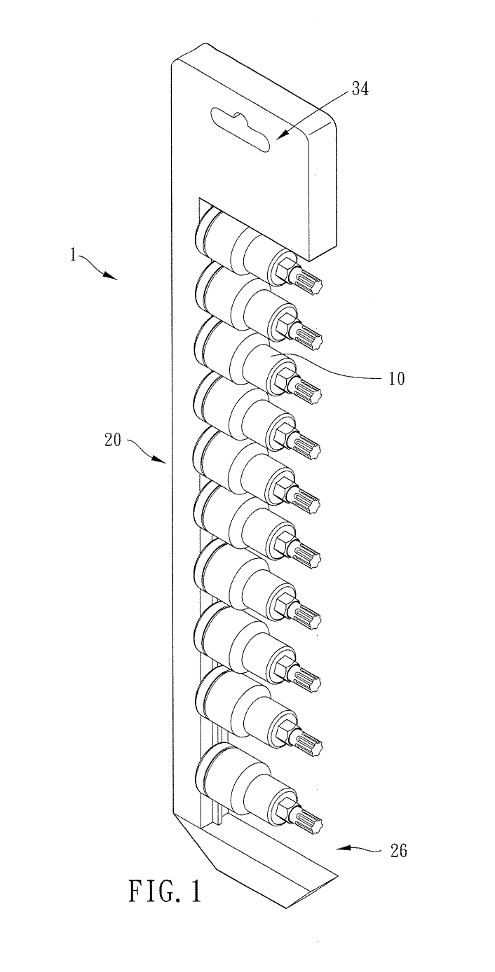

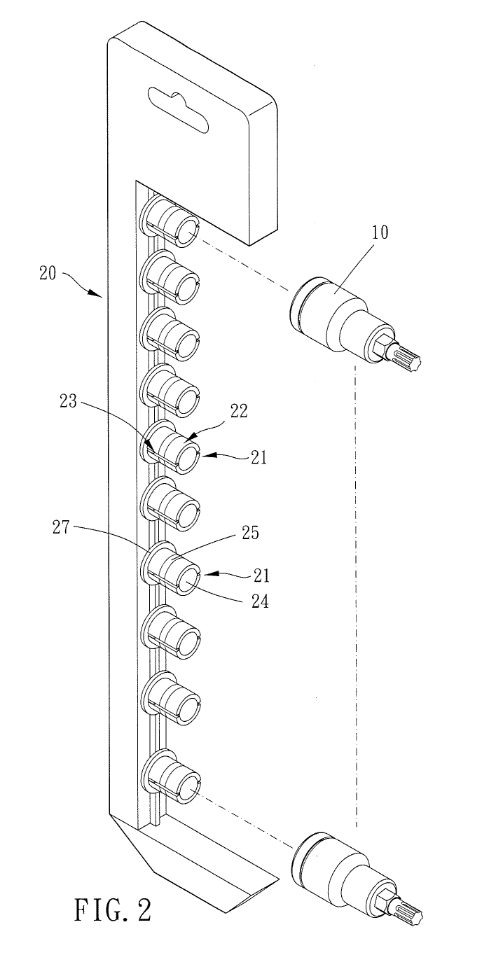

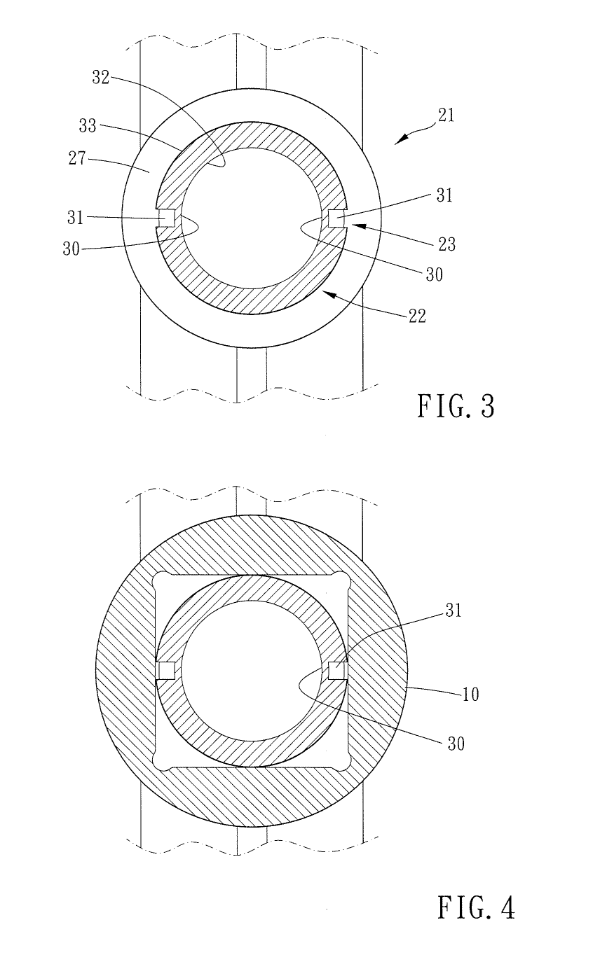

Please refer to FIGS. 1 to 4 for a first preferred embodiment of the present invention. A display board for tool 1 includes a main body 20.

The main body 20 has at least one socket assembling base 21, and the socket assembling base 21 may be provided for a socket 10 to be assembled thereto along an axial direction of the socket assembling base 21. A circumferential wall 22 of the socket assembling base 21 is formed with at least one material-reduced portion 23, and the material-reduced portion 23 extends in a direction non-perpendicular to the axial direction. The material-reduced portion 23 unpenetrates through the circumferential wall 22 of the socket assembling base 21, so the circumferential wall 22 is solidly continuous.

Given the above, the circumferential wall 22 of the socket assembling base 21 may be formed with a plurality of the material-reduced portions 23, and the material-reduced portions 23 are arranged equidistantly. For example, in this embodiment, the socket assembling base 21 may be surroundingly formed with two said material-reduced portions 23, and the two material-reduced portions 23 are symmetrically arranged corresponding to each other. Specifically, the circumferential wall 22 and the two material-reduced portions 23 are integrally formed and may be manufactured through plastic injection.

The socket assembling base 21 is cylindrical. The socket assembling base 21 is formed with a central hole 24 along the axial direction, and the central hole 24 is round. Specifically, in this embodiment, the circumferential wall 22 may be curved as viewed from the axial direction, and the circumferential wall 22 extends along the axial direction and is swingable laterally; however, in other embodiments, the circumferential wall 22 may be square. When the socket 10 is sleeved on the socket assembling base 21, an outer circumferential surface 33 of the circumferential wall 22 is for interferentially engaging with the socket 10, wherein the circumferential wall 22 is elastically deformable to tightly abut against the socket 10.

It is to be noted that because the circumferential wall 22 is curved, the socket 10 is rotatable relative to the socket assembling base 21; therefore, it is convenient for a user to rotate the socket 10 to adjust a position of the socket 10 (for example, the socket 10 may be rotated to show a pattern on a lateral face of the socket 10). The outer circumferential surface 33 may further include a protrusion 25 radially disposed thereon, and the protrusion 25 may be surroundingly disposed on the outer circumferential surface 33. The protrusion 25 is for being correspondingly engaged with an engaging slot on an inner wall of the socket 10, so the socket 10 is sleeved on the socket assembling base 21 more stably. The socket 10 is fittingly assembled to the outer circumferential surface 33 and engaged with the engaging slot of the socket 10 through the protrusion 25 so that the protrusion 25 can tightly abut against the socket 10. An outer diameter of the protrusion 25 is substantially 0.1 mm to 0.3 mm greater than an outer diameter of the outer circumferential surface 33, and along the axial direction, a width of the protrusion 25 is substantially a quarter of a total length of the socket assembling base 21.

The material-reduced portion 23 includes a thinned wall 30 and at least one recessed slot 31 corresponding to the thinned wall 30. The thinned wall 30 and the at least one recessed slot 31 extend from a distal end of the socket assembling base 21 toward an end of the socket assembling base 21 which is opposite to the distal end. More specifically, in this embodiment, the recessed slot 31 may be recessed from the outer circumferential surface 33 of the socket assembling base 21, and the thinned wall 30 is connected and aligned with an inner circumferential surface 32 of the circumferential wall 22 of the socket assembling base 21. The thinned wall 30 is resiliently deformable. Specifically, a radial thickness of the thinned wall 30 is smaller than a greatest radial thickness of the circumferential wall 22. For example, the radial thickness of the thinned wall 30 may substantially be a fifth of the greatest radial thickness of the circumferential wall 22. When the socket 10 is sleeved on the socket assembling base 21, the thinned wall 30 may deform to allow the socket 10 to be sleeved on the circumferential wall 22. In addition, since the circumferential wall 22 is solidly continuous, the circumferential wall 22 has preferable structural strength, and the durability of the socket assembling base 21 is elevated.

Given the above, the recessed slot 31 extends substantially along the axial direction; however, in other embodiments, the recessed slot 31 may be oblique relative to the axial direction. The thinned wall 30 is deformably movable toward the recessed slot 31. Specifically, when the socket 10 is sleeved on the circumferential wall 22, the recessed slot 31 allows the circumferential wall 22 to elastically deform and move therein; therefore, the socket 10 can be sleeved on the socket assembling base 21 conveniently.

In actual practice, the main body 20 may be further formed with an assembling groove 26. The assembling groove 26 is substantially C-shaped as viewed in a lateral direction. The main body 20 may further include a plurality of the socket assembling bases 21 which are arranged on an inner wall of the assembling groove 26 in intervals, and the plurality of the socket assembling bases 21 may be for sockets in different dimensions to be sleeved thereon. An end of the main body 20 may be formed with a hanging portion 34 for hanging. A bottom end of each said socket assembling base 21 may further has an abutting portion 27, and the abutting portion 27 may be for an end of the socket 10 to abut thereagainst to position the socket 10. It is to be noted that the solidly continuous circumferential wall 22 is not prone to material fatigue after being folded repeatedly, so the circumferential wall 22 has preferable durability and makes the socket 10 uneasy to loose off from the socket assembling base 21.

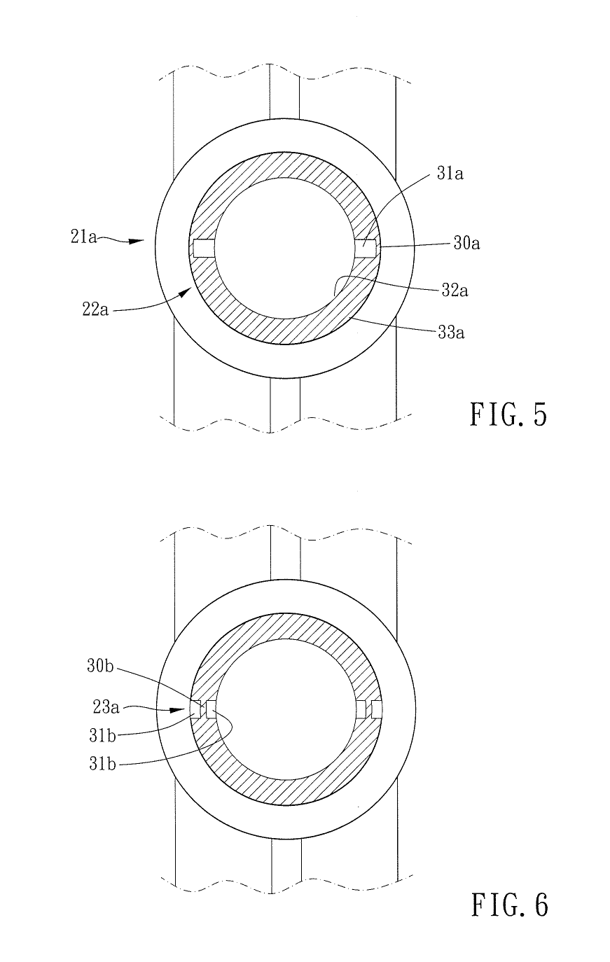

In a second embodiment as shown in FIG. 5, a recessed slot 31a may be recessed from an inner circumferential surface 32a of a circumferential wall 22a of a socket assembling base 21a, and a thinned wall 30a may be connected and aligned with an outer circumferential surface 33a of the circumferential wall 22a of the socket assembling base 21a.

In a third embodiment as shown in FIG. 6, a material-reduced portion 23a includes a thinned wall 30b and two recessed slots 31b, and the two recessed slots 31b are correspondingly recessed and located on two opposite sides of the thinned wall 30b. The two recessed slots 31b are deformable for the socket to be assembled thereto and have preferable durability and product stability.

Given the above, the display board for tool of the present invention is provided, wherein the circumferential wall is solidly continuous, so the circumferential wall has preferable structural strength and durability. In addition, the display board for tool is not prone to material fatigue and has preferable durability so as to elevate product stability. Furthermore, the display board for tool can be integrally formed by plastic injection, so it is time-saving, fast and convenient to manufacture the display board for tool.

While we have shown and described various embodiments in accordance with the present invention, it should be clear to those skilled in the art that further embodiments may be made without departing from the scope of the present invention.

What is claimed is:

1. A display board for tool, including:
a main body, having at least one socket assembling base, the socket assembling base provided for a socket to be assembled thereto along an axial direction of the socket assembling base, a circumferential wall of the socket assembling base formed with at least one material-reduced portion, the material-reduced portion extending in a direction non-perpendicular to the axial direction, the material-reduced portion unpenetrating through the circumferential wall of the socket assembling base.

2. The display board for tool of claim 1, wherein the material-reduced portion includes a thinned wall and at least one recessed slot corresponding to the thinned wall, the thinned wall and the at least one recessed slot extend from a distal end of the socket assembling base toward an end of the socket assembling base which is opposite to the distal end.

3. The display board for tool of claim 2, wherein the recessed slot is recessed from an outer circumferential surface of the circumferential wall of the socket assembling base, and the thinned wall is connected and aligned with an inner circumferential surface of the circumferential wall of the socket assembling base.

4. The display board for tool of claim 2, wherein the recessed slot is recessed from an inner circumferential surface of the circumferential wall of the socket assembling base, and the thinned wall is connected and aligned with an outer circumferential surface of the circumferential wall of the socket assembling base.

5. The display board for tool of claim 2, wherein the material-reduced portion includes one said thinned wall and two said recessed slots, and the two said recessed slots are correspondingly recessed and located opposite to each other on two opposite sides of the thinned wall.

6. The display board for tool of claim 2, wherein an outer circumferential surface of the circumferential wall is for interferentially engaging with the socket, the outer circumferential surface further includes a protrusion radially formed thereon, and the protrusion is for correspondingly engaging with an engaging slot in an inner wall of the socket.

7. The display board for tool of claim 6, wherein an outer diameter of the protrusion is substantially 0.1 mm to 0.3 mm greater than an outer diameter of the outer circumferential surface, and along the axial direction, a width of the protrusion is substantially a quarter of a total length of the socket assembling base.

8. The display board for tool of claim 2, wherein a radial thickness of the thinned wall is substantially a fifth of a greatest radial thickness of the circumferential wall.

9. The display board for tool of claim 1, wherein the circumferential wall of the socket assembling base is formed with a plurality of the material-reduced portions, and the material-reduced portions are arranged equidistantly.

10. The display board for tool of claim 3, wherein the recessed slot is formed substantially along the axial direction, the circumferential wall is solidly continuous, the socket assembling base is cylindrical, the socket assembling base is formed with a central hole along the axial direction, the central hole is round, the main body has an assembling groove, the assembling groove is substantially C-shaped as viewed in a lateral direction, the main body includes a plurality of the socket assembling bases arranged on an inner wall of the assembling groove in intervals, an end of the main body has a hanging portion, a bottom end of each said socket assembling base further has an abutting portion, and the abutting portion is for an end of the socket to abut thereagainst.
